(19) United States
(12) Patent Application Publication
(10) Pub. No.: US 2002/0131704 A1
(43) Pub. Date: Sep. 19, 2002

(54) Low loss multiplexer/demultiplexer with high spectral sampling

(76) Inventor: Christopher Richard Doerr, Middletown, NJ (US)

Correspondence Address: Docket Administrator (Rm. 3C-512), Lucent Technologies Inc., 600 Mountain Avenue, P.O. Box 636, Murray Hill, NJ, 07974-0636, US

(21) Appl. No.: 09/809,933

(22) Filed: Mar. 16, 2001

(51) Int. Cl. G02B 6/34; G02B 6/12; G02B 6/293

(52) U.S. Cl. 385/37; 385/14; 385/24; 385/46

(57) ABSTRACT

Segmentation is used not only in the grating side of a star coupler, but also on the input/output side of a star coupler, in order to minimize the amount of light that is lost. Thus, our invention is to place segmentation in the input and/or output ports of optical planar waveguide grating routers with high spectral sampling, for the purpose reducing insertion loss. In one embodiment, the star couplers in the waveguide grating router are arranged with segmentation on both input and output sides; alternatively, segmentation is used only on either the input or output side of the star coupler.

### FIELD OF THE INVENTION

This invention pertains to the reduction of the insertion loss of planar (slab) waveguide optical multiplexers and demultiplexers.

### BACKGROUND OF THE INVENTION

An optical multiplexer/demultiplexer (hereafter referred to as a “mux” or as a “waveguide grating router”) can be constructed as shown in FIG. 1 out of a planar arrangement 150 of waveguides with increasing path length connected between two star couplers 101, 102, as described in U.S. Pat. No. 5,002,350 by C. Dragone. As shown in FIG. 1, star coupler 101 has a central slab waveguide 161 and an input/output side 111 (on the left in FIG. 1) for receiving an incoming signal and a grating side 120 (on the right in FIG. 1) for power splitting the input signal and coupling portions of the signal to the waveguides in the planar waveguide arrangement 150. The output ends of the individual waveguides in the planar waveguide arrangement 150 are coupled to the grating side 130 of a second star coupler 102, which has a central slab waveguide 162 that power combines the optical signals and applies these combined signals to a series of coupler outputs 112 on the right (input/output) side of coupler 102. Note that the operation just described operates as, and constitutes a demultiplexer. The device can also operate as, and constitute, a multiplexer, when operated in the reverse direction.

It has been shown in U.S. Pat. No. 5,745,618 by Y. P. Li that the insertion loss can be reduced by placing waveguides 121, 122 perpendicular to the waveguides in the array near the star-coupler slabs 161 and 162, as shown in FIG. 2. These waveguides progressively decrease in width as their distance from the slabs 161 and 162 increases. Specifically, waveguides 121 are perpendicular to the waveguides in the grating side 120 of coupler 101, while waveguides 122 are perpendicular to the waveguides in grating side 130 of star coupler 102. This use of perpendicular waveguides is called “segmentation”. It works because the transmissivity between the waveguide array and the free-space region of the star coupler is mainly given by the overlap integral between the local normal mode of the waveguide array at the free-space boundary and a two-dimensional plane wave. The segmentation raises the effective index in the gaps between the waveguides, making the local normal mode more like a plane wave, thus increasing the transmissivity.

A typical mux, such as in FIG. 1, has spectral undersampling. This means that the transmissivities through the mux consist of well separated passbands. Looking from one port on one side to all the ports on the other of the mux the transmissivity is high for only selected wavelengths. In other words, a significant portion of the light that falls between the input/output ports is lost. If the spatial spacing between the ports is α at the star-coupler boundary, then the ratio of the angle λ/α to the width of the angular region occupied by the grating arms at the star coupler boundary is the spectral sampling. λ is the wavelength in the free-space region. If the spectral sampling is less than 1, then the spectrum is undersampled. If the spectral sampling is equal to 1, then the sampling is “perfect”, and adjacent passbands cross at their half-way points.

It has been found that for many applications one would like to have a high spectral sampling. For example, for a multiplexer, one does not usually care about crosstalk, and one would usually like the passbands to be as wide as possible; so one would like the multiplexer to have a high spectral sampling. In fact, some applications would like a spectral sampling of 1, such as for a dynamic spectral equalizer or wavelength add-drop. These devices consist of two back-to-back muxes (or one mux and a mirror), and if the spectral sampling is 1 of the muxes, then the transmissivity through the entire device can be perfectly spectrally flat. This spectral flatness minimizes signal distortion.

### SUMMARY OF THE INVENTION

We have recognized that segmentation (i.e., the placing of waveguides that are perpendicular to the waveguides of a coupler) can be used not only in the grating side of a star coupler, but can also be used on the input/output side of a star coupler, in order to minimize the amount of light that is lost. Thus, our invention is to place segmentation in the input and/or output ports of optical waveguide grating router with high spectral sampling, for the purpose reducing insertion loss. In one embodiment, the star couplers in the waveguide grating router are arranged with segmentation on both input and output sides; alternatively, segmentation is used only on either the input or output side of the waveguide grating router.

From the optical device point of view, the present invention contemplates an optical device comprising a slab waveguide with two or more input waveguide and two or more output waveguides characterized by transition regions, which are immediately adjacent to the slab waveguide. The transition region includes waveguides that run perpendicular to the input and output waveguides, and have widths that progressively decrease as they become further away from the slab.

### BRIEF DESCRIPTION OF THE DRAWING

The present invention will be fully appreciated by consideration of the following Detailed Description, which should be read in light of the accompanying drawing in which:

FIG. 1 illustrates a prior art arrangement of planar waveguides with increasing path length connected between two star couplers, as described in U.S. Pat. No. 5,002,350 by C. Dragone;

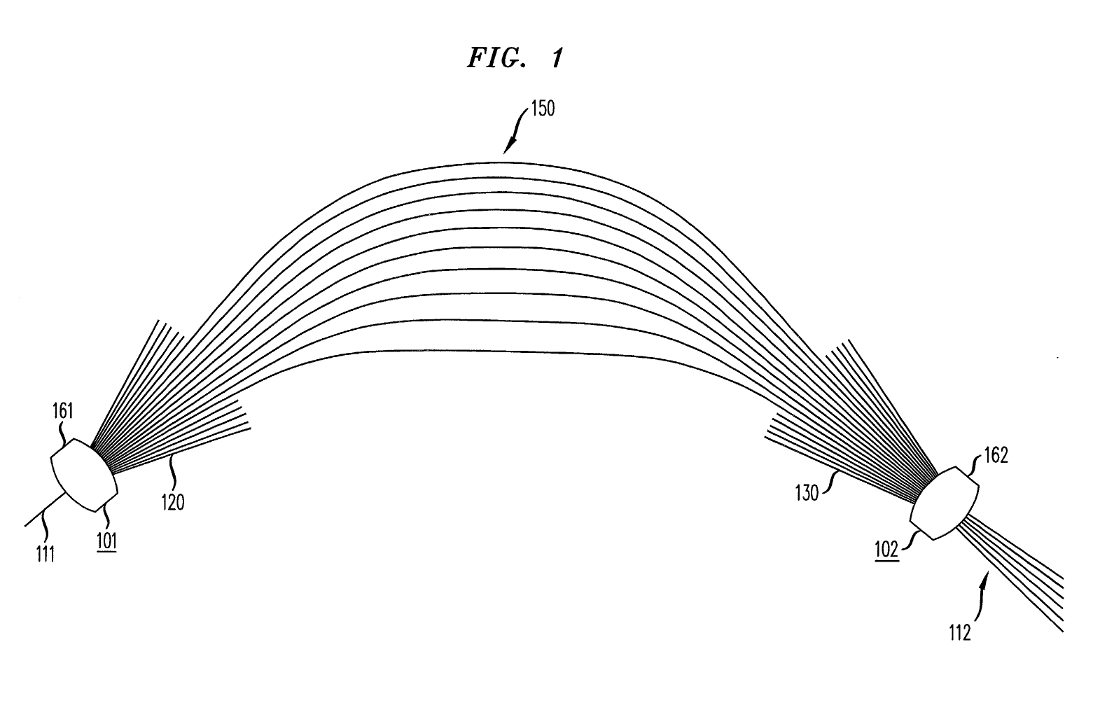

FIG. 2 illustrates a prior art arrangement of planar waveguides with increasing path length connected between two star couplers, in which the insertion loss is reduced by placing waveguides on the grating side of the couplers, perpendicular to the waveguides in the array, as shown in U.S. Pat. No. 5,745,618 by Y. P. Li;

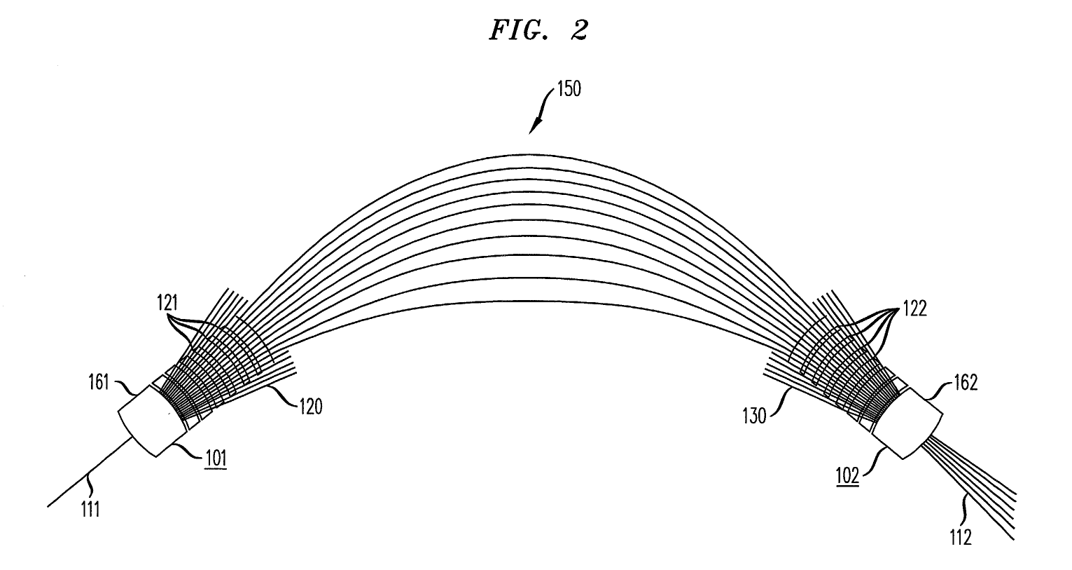

FIG. 3 is illustrates an arrangement of planar waveguides with increasing path length connected between two star couplers that, in accordance with the present invention, includes segmentation in one of the couplers (coupler 102), on not only its grating side, but also on its output side, and

FIG. 4 is illustrates an arrangement of planar waveguides with increasing path length connected between two star couplers that, in accordance with the present invention, includes segmentation in both couplers (couplers 101 and 102), on not only the grating sides, but also on the input/output sides of the couplers, namely, on the input side of coupler 101 and on the output side of coupler 102.

### DETAILED DESCRIPTION

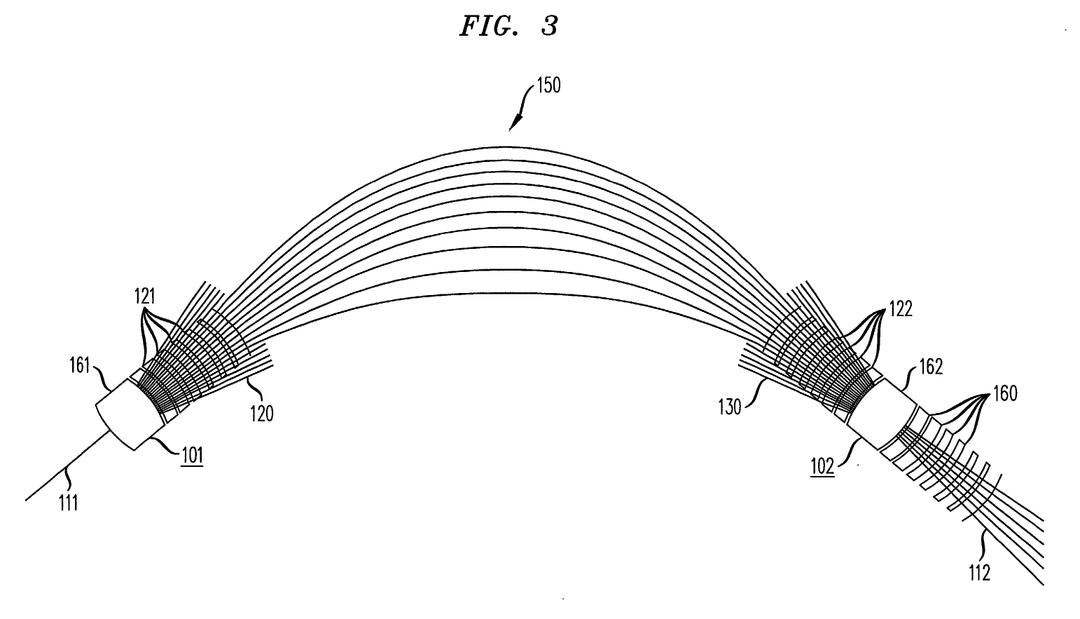

Referring to FIG. 3, there is illustrated an arrangement of planar waveguides with increasing path length connected between two star couplers that, in accordance with the present invention, includes segmentation in both couplers, on not only the grating sides, but also on the output side of one of the couplers.

A first star coupler 101 has an input/output side (left side) connected to an input waveguide 111, a central slab waveguide 161, and a grating side 120 coupled to an array 150 of planar waveguides of differing lengths. A second star coupler 102 has its grating side (left side in FIG. 3) connected to the outputs of the waveguides in the array 150 of planar waveguides, a central slab waveguide 162, and its input/output side (right side in FIG. 3) connected to multiple output waveguides 112. In accordance with the invention, segmentation (i.e., the placing of waveguides that are perpendicular to the waveguides of a coupler) is used (a) in coupler 101 on the grating side of the coupler, by virtue of waveguides 121, and (b) in coupler 102 on both the grating side of the coupler, by virtue of waveguides 122, and also in the output side, by virtue of waveguides 160.

It will be observed from FIG. 3 that, from the optical device point of view, the present invention contemplates an optical device (coupler 102) comprising a slab waveguide 162 with two or more input waveguides (i.e., waveguides 150) and two or more output waveguides (waveguides 112) characterized by transition regions (in the vicinity of waveguides 122 and 160), which are immediately adjacent to the slab waveguide 162. The transition regions include waveguides 122 and 160, respectively, that run perpendicular to the input and output waveguides (150 and 112, respectively), and have widths that progressively decrease as they become further away from the slab waveguide 162.

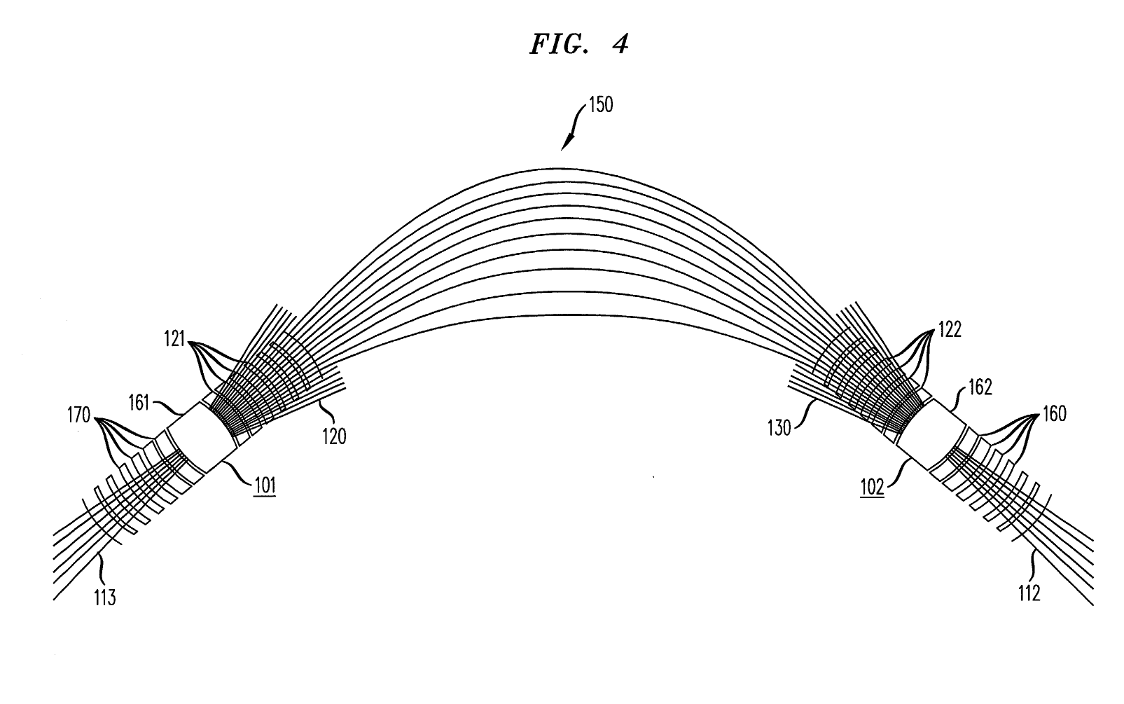

FIG. 4 is very similar to FIG. 3. However, in the arrangement illustrated, coupler 101 has multiple input waveguides 113. In this figure, both couplers 101 and 102 have segmentation (i.e., the placing of waveguides that are perpendicular to the waveguides of a coupler) in both the grating side of the coupler and in the input/output side of the coupler. Specifically, coupler 101 has segmentation 170 in its input waveguide 113 side and segmentation 121 in its grating side, and coupler 102 has segmentation 122 in its grating side and segmentation 160 its output side 112.

The invention of FIGS. 3 and 4 are advantageous in arrangements with high spectral sampling, because it decreases the insertion loss. When designing a mux with high spectral sampling, one generally has the conflicting requirements to make the input/output waveguides as close together as possible and yet also make the input/output waveguides as wide as possible. Since there must be finite gaps between the waveguides to realize a device, one must compromise and accept additional insertion loss. However, by using segmentation in the input and/or output waveguide array(s), as shown in FIG. 3, then the loss due to the gaps is significantly reduced (because the segments reduce the effective index step between the core and cladding). This modification requires no extra fabrication steps; it is simply a change in the waveguide layout. Using segmentation on both sides, as in FIG. 4, can be advantageous in that the input and output effective waveguide modes are matched (because of the symmetry of the device), further reducing the insertion loss.

Various additional modifications of this invention will occur to those skilled in the art. Nevertheless, all deviations from the specific teachings of this specification that basically rely upon the principles and their equivalents through which the art has been advanced are properly considered within the scope of the invention as described and claimed.

I claim:

1. An optical device comprising a slab waveguide having (a) two or more input waveguides and two or more outputs waveguides, and (b) transition regions immediately adjacent to and on both sides of the slab waveguide, wherein said device is characterized by waveguides in said transition regions that run perpendicular to the input and output waveguides and have widths that progressively decrease as they become further away from the slab waveguide.

2. An optical multiplexer/demultiplexer comprising
a first star coupler connected to a waveguide array,
a second star coupler connected to said waveguide array and to an output waveguide array, said second star coupler having a central slab waveguide,
wherein transition regions on both the grating side and the output side of said central slab waveguide include perpendicular waveguides having widths than progressively decrease as they become further away from said central slab waveguide.

3. A star coupler having (a) a central slab waveguide, (b) a first waveguide array for coupling optical signals into (out of) said slab waveguide, and (c) a grating for receiving optical signals from (coupling optical signals to) said slab waveguide,
wherein first and second transition regions between (1) said central slab waveguide and said first waveguide array and (2) said central slab waveguide and said grating, both include perpendicular waveguides having widths than progressively decrease as they become further away from said central slab waveguide.
